(19) United States
(12) Patent Application Publication
(10) Pub. No.: US 2011/0187703 A1
(43) Pub. Date: Aug. 4, 2011

(54) METHOD AND SYSTEM FOR OBJECT TRACKING USING APPEARANCE MODEL

(76) Inventors: Kedar Anil Patwardhan, Niskayuna, NY (US); Ting Yu, Schenectady, NY (US); Nils Krahnstoever, Schenectady, NY (US)

(21) Appl. No.: 12/696,424

(22) Filed: Jan. 29, 2010

(51) Int. Cl. G06T 15/00; H04N 5/225; G06K 9/00

(52) U.S. Cl. 345/419; 348/169; 382/103; 348/E05.024

(57) ABSTRACT

A method and system are provided for tracking an object, such as a person, within in a scene. The system/method receives input to track an object of interest in a scene with one or more image capture devices, captures a 2D image of the object, creates via an image processing system a 4D model of the object, and then uses the model to provide enhanced tracking of the object.

### FIELD OF THE INVENTION

The subject matter disclosed herein relates to object tracking and specifically to an improved system, method, and computer-readable instructions for object tracking by creating an appearance model from a two-dimensional (2D) image of the object.

### BACKGROUND OF THE INVENTION

Object tracking systems are used to track objects within images, such as video-based security systems. Tracking is the process of moving the field of view of a camera, or other imaging system, to follow a particular object of interest or to highlight an individual or object of interest continually over time. Various methods have been used to track objects, such as geometric methods using edge matching, color indexing (color histogram/statistical model of colors in object), and the like.

In applications such as surveillance or monitoring, it is often necessary to track the movements of one or more people and/or objects in a scene monitored by one or more video cameras. Such surveillance or monitoring systems generally include video cameras operatively coupled by a network to a computer workstation. The network may be a local area network, the Internet, some other type of network, a modem link or a combination of these technologies. The computer workstation may be a personal computer including a processor, a keyboard, a mouse and a display unit. In monitored scenes, real-world objects move in unpredictable ways. They may move close to one another and may occlude each other. For example, when a person moves, the shape of his or her image changes. These factors make it difficult to track the locations of individual objects throughout a scene containing multiple objects.

In known object tracking techniques, typically only a two-dimensional 2D image based appearance of a scene object is used for tracking. Due to the three-dimensional 3D nature of the real world, such a 2D model does not accurately capture the appearance of the object (especially in case of articulated objects), as the 2D image of a moving object would look different (even in size) as it moves through different locations in the scene. This type of appearance also does not handle occlusions well.

Also, typically such systems use an object or person detector to enable accurate tracking and are handicapped in case the detector is unable to find the person/object of interest.

There is a need for interactive automated tracking of an object/person of interest through crowds and in spite of partial as well as sometimes complete occlusions. There is also a need for a simpler and flexible solution which could track objects of all types without compromising tracking performance.

### BRIEF DESCRIPTION OF THE INVENTION

In one aspect thereof, the present invention provides a method of object tracking in an image processing system, including: capturing via an image capture device a two-dimensional image comprising an object of interest; generating via a processor in an image processing system a three-dimensional 3D shape model from the 2D image; constructing via the processor an appearance model from the 3D shape model combined with extracted appearance features from the 2D image; and outputting tracking information for the object of interest based on the appearance model.

In another aspect thereof, the present invention provides for an object tracking system for tracking an object, the object tracking system that includes: one or more image capture devices; and a computer system coupled to the one or more image capture devices, the computer system having a memory, a processor, wherein the processor is programmed to: receive a two-dimensional image comprising an object of interest captured via the one or more image capture devices; generate a three-dimensional 3D shape model from the 2D image; construct an appearance model from the 3D shape model combined with extracted appearance features from the 2D image; outputting tracking information for the object of interest based on the appearance model.

In another aspect thereof, the present invention provides a computer readable medium for implementing object tracking in an image processing system, including code devices for: capturing via an image capture device a two-dimensional image comprising an object of interest; generating via a processor in an image processing system a three-dimensional 3D shape model from the 2D image; constructing via the processor an appearance model from the 3D shape model combined with extracted appearance features from the 2D image; and outputting tracking information for the object of interest based on the appearance model.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an image processing system in which an embodiment of the invention may be implemented.

FIG. 2 shows a simplified flow chart of the object tracking according to an embodiment of the present invention.

FIG. 3 shows a more detailed flow chart of the object tracking according to an embodiment of the present invention.

FIG. 4 is a representation of a rectilinearized 2D projection.

FIG. 5 is a diagram of approximating each edge of the polygon with a set of horizontal-vertical zigzag triangles.

FIG. 6 is a flowchart of computation of image features inside a shape.

FIG. 7 is a detailed flowchart of the Image-Based Ground-Plane Median-Shift algorithm.

FIG. 8 shows tracking of an embodiment of the invention using Euclidean distance plus appearance dissimilarity.

FIG. 9 is a representation showing orientation of a person in the 2D image

### DETAILED DESCRIPTION OF THE INVENTION

Aspects of the present invention offer an improved method and system for tracking an object, such as a person, within an image. The system/method receives input to track an object of interest, captures a 2D image of the object, creates a 3D shape model (such as an ellipsoid for tracking persons) and constructs an appearance model such as a 4D histogram of the object, and then uses this appearance model to provide enhanced tracking of the object. Broadly speaking, aspects of the present invention provide a video (moving image) based interactive tool for an operator to track a particular individual or object of interest. The system receives operator input (e.g., a mouse click) to select the object/individual of interest from one or more camera views (e.g., 2D image/view), and then automatically creates a 3D shape model of the object. Appearance features are then extracted to create a 4D histogram resulting in an appearance model. This appearance model is used to track the object/individual of interest throughout the field(s) of view. The system also continuously updates the appearance of the object/person of interest which leads to robust tracking performance in spite of occlusions and crowded environments. This system does not need to use any specific object or person detector for the purpose of tracking.

Aspects of the invention can be implemented in numerous ways, including as a system, a device/apparatus, a method, or a computer readable medium. Several embodiments of the invention are discussed below.

As a method of object tracking, an embodiment of the invention includes the operations of: capturing via an image capture device a two-dimensional image comprising an object of interest; generating via a processor in an image processing system a three-dimensional 3D shape model from the 2D image; constructing via the processor an appearance model from the 3D shape model combined with extracted appearance features from the 2D image; and outputting tracking information for the object of interest based on the appearance model.

It further provides for displaying on a screen a field of view from at least one image capture device monitoring a scene and receiving input from an operator to track the object of interest from the scene displayed on the screen, wherein the input identifies positional information for the object of interest and wherein the input comprises an input from a graphical user interface input device that allows for selection of a location and a pose of the object of interest on a ground-plane in the scene to initialize a target location.

In another aspect thereof, the present invention provides for generating the three-dimensional 3D shape model from the 2D image by approximating a shape of the object of interest as a 3D ellipsoid, wherein the three-dimensional 3D shape model is generated from the 2D image by approximating a shape of the object of interest and wherein a 2D projection silhouette of the object of interest is pre-computed using image capture device parameters, and appearance features are extracted from pixels inside the 2D projection silhouette, where the extracted appearance features comprise color information so that the appearance model is constructed from the 3D shape model by combining the extracted appearance features into a 4D histogram comprising color (R, G, B) and an approximated height (h).

In another aspect thereof, the present invention provides for tracking the object of interest using Euclidean distance and appearance dissimilarity based on the appearance model to locate target appearances in a tracking image corresponding to the appearance model, where the object is tracked using an image-based-ground-plane-median-shift algorithm by: locating one or more possible target appearances in a tracking image; computing a distance between the appearance model and the one or more possible target appearances; comparing the appearance model with the one or more possible target appearances based on distance and appearance dissimilarity; selecting one target appearance out of the one or more possible target appearances based on the comparison; and updating the appearance model with information from the selected one target appearance. A confidence level may be computed to determine tracking success or failure for the selected one target appearance and if tracking success is determined, continuing tracking, otherwise outputting an indication of tracking failure.

The method is performed on a physical device(s), namely a computing device having a memory, a display device, input device, and a processor unit. The method further includes processing the information and storing it on at least one computer-accessible storage device. The method receives information from a real world physical system, namely a video image monitoring system which captures images of real-world objects, transforms this data into statistical models, and outputs data for tracking. The method may further control a real world physical system, namely positioning of tracking cameras.

Embodiments of the methods of the present invention may be implemented as a computer program product with a computer-readable medium having code thereon.

As a system, an embodiment of the invention includes one or more cameras connected to a computing device, such as a computer system. The computer system comprises, for example, memory, a display device, input device, and a processor unit and may further be connected to a database. The processor unit operates to receive input from a user, process this information, access the database, and output/display results. The system may include one or more image capture devices; and a computer system coupled to the one or more image capture devices, the computer system having a memory, a processor, wherein the processor is programmed to implement the steps of the invention.

As an apparatus, aspects of the present invention may include at least one processor, a memory coupled to the processor, and a program residing in the memory which implements the methods of the present invention.

As a computer readable medium containing program instructions for object tracking, an embodiment of the invention includes: computer readable code devices for receiving a two-dimensional image comprising an object of interest captured via the one or more image capture devices; generating a three-dimensional 3D shape model from the 2D image; constructing an appearance model from the 3D shape model combined with extracted appearance features from the 2D image; and outputting tracking information for the object of interest based on the appearance model.

The invention includes a number of software components, such as an image capturing and processing module, a statistical modeling module, a tracking module, and an output module, that are embodied upon a computer readable medium.

As such, aspects of the system and method of the present invention allows for tracking an object/person of interest throughout the field(s) of view of one or more cameras, such as a video camera. An object is an abstract entity which represents a real-world object. The system receives input from an operator to track a person of interest (real-world object), such as by receiving a mouse click identifying an image of the object on a display from a particular camera view. (An image is a picture consisting of an array of pixels). The system captures this 2D image of the target object, including color information. The object of interest is then processed by the system to provide for tracking by using known camera information to generate a 3D shape model from the 2D projection (for example 3D ellipsoid shape for human based tracking). Appearance features are extracted and an appearance model (say, a 4D histogram) is created for the object of interest (e.g., calculate/normalize height based on ellipsoid and define a 4D (3 color+height) model).

Using this appearance model, the object of interest is then tracked throughout the camera views (a scene) using appearance based tracking (e.g., using a combination of Euclidean distance computed in the 3D world (not in the 2D image) and appearance dissimilarity to compute likelihood). The tracking considers the whole body (3D) appearance of the object/person instead of the 2D image of the object/person (which would change in size and appearance as the object/person moves through the scene). The computer looks for portions in the tracking image corresponding to the appearance model. The target appearance may be updated as more information becomes available for better tracking The system outputs information regarding tracked object (e.g., shows tracked object on screen/display).

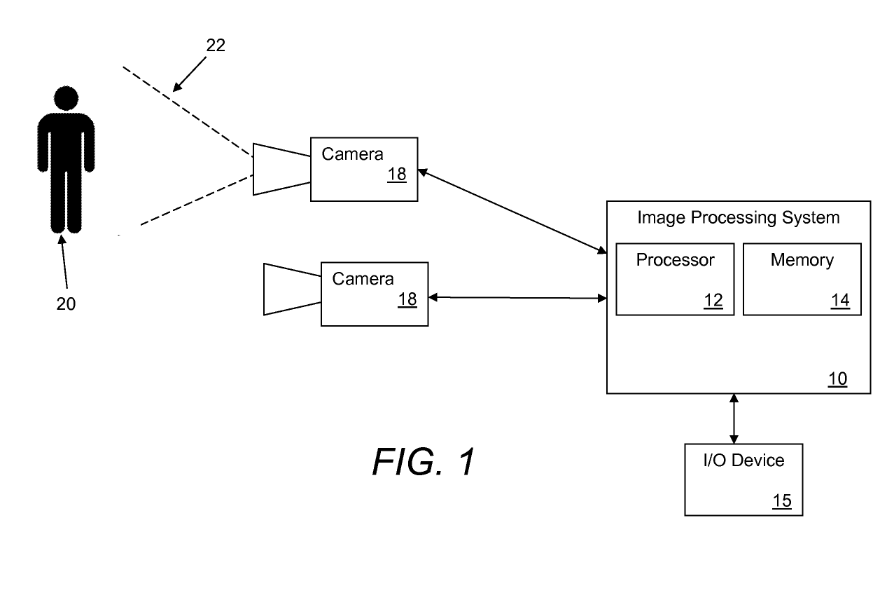

FIG. 1 shows an image processing system 10 in which object tracking techniques in accordance with aspects of the invention may be implemented. The system 10 includes a processor 12, a memory 14, and an input/output (I/O) device 15, all of which are connected to communicate over a set of one or more system buses or other type of interconnections. The system 10 further includes one or more cameras 18 that may be coupled to an optional controller (not shown). The camera 18 may be, e.g., a mechanical pan-tilt-zoom camera, a wide-angle electronic zoom camera, or any other suitable type of image capture device. It should therefore be understood that the term “camera” as used herein is intended to include any type of image capture device as well as any configuration of multiple such devices. Various components of the system may be local or remote as known in the art.

The system 10 may be adapted for use in any of a number of different image processing applications, including, e.g., video conferencing, video surveillance, human-machine interfaces, etc. More generally, the system 10 can be used in any application that can benefit from the improved object tracking capabilities provided by aspects of the present invention.

In operation, the image processing system 10 generates a video signal or other type of sequence of images of an object 20. The camera 18 may be adjusted such that the object 20 comes within a field of view 22 of the camera 18. A video signal corresponding to a sequence of images generated by the camera 18 is then processed in system 10 using the object tracking techniques of embodiments of the invention, as will be described in greater detail below.

An output of the system may then be adjusted based on the detection of a particular tracked object in a given sequence of images. For example, a video conferencing system, human-machine interface or other type of system application may generate a query or other output or take another type of action based on the detection of a tagged person. Any other type of control of an action of the system may be based at least in part on the detection of a tracked object.

Elements or groups of elements of the system 10 may represent corresponding elements of an otherwise conventional desktop or portable computer, as well as portions or combinations of these and other processing devices. Moreover, in other embodiments of the invention, some or all of the functions of the processor 12, memory 14, and/or other elements of the system 10 may be combined into a single device. For example, one or more of the elements of system 10 may be implemented as an application specific integrated circuit (ASIC) or circuit card to be incorporated into a computer, television, set-top box or other processing device.

The term “processor” as used herein is intended to include a microprocessor, central processing unit (CPU), microcontroller, digital signal processor (DSP) or any other data processing element that may be utilized in a given image processing system. In addition, it should be noted that the memory 14 may represent an electronic memory, an optical or magnetic disk-based memory, a tape-based memory, as well as combinations or portions of these and other types of storage devices.

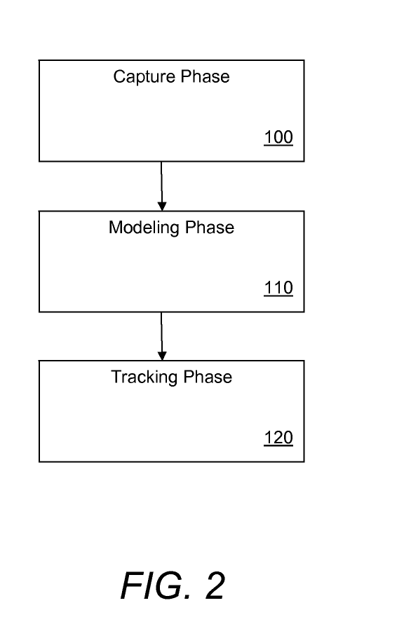

The system operates in three main phases, as sown in the flowchart of FIG. 2: the Capture Phase 100, the Modeling Phase 110, and the Tracking Phase 120.

In the Capture Phase 100, to capture an object of interest 20 in the field of view 22 of one or more cameras 18 (e.g., person of interest POI) the system receives a user input, such as a mouse click. In a particular embodiment, the user selects the location and pose of a target on ground-plane in a 2D image of the scene obtained from one of the camera views. This will initialize target location and capture certain data about the object.

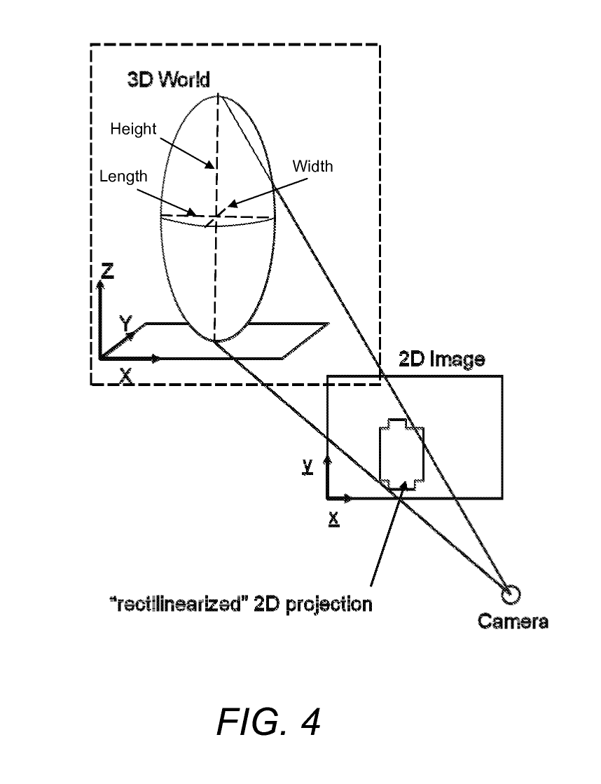

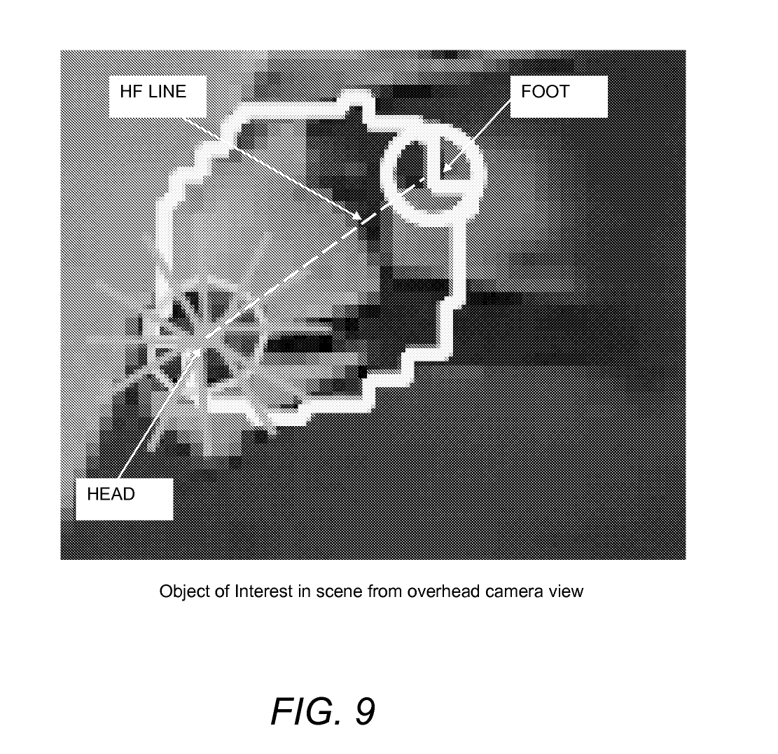

In the Modeling Phase 110, appearance initialization takes place. In the case of tracking people, the shape of a person is approximated by a 3D ellipsoid in the real world (See FIG. 4). A 2D projection silhouette of this 3D person can be pre-computed using known camera parameters. In certain embodiments, a rectilinearized 2D projection is used. Appearance features are then extracted from pixels inside the 2D silhouette (e.g., color RGB features and height from ground plane (h). Head (H) and Foot (F) locations are known from the pre-computed projections. A line HF provides orientation of the person in the 2D image (See FIG. 9). Each pixel inside the silhouette has a R, G, B value as well as a height (h computed from the foot). These extracted appearance features are “binned” into a 4D histogram (R, G, B, h) that captures the 4D target “appearance.”

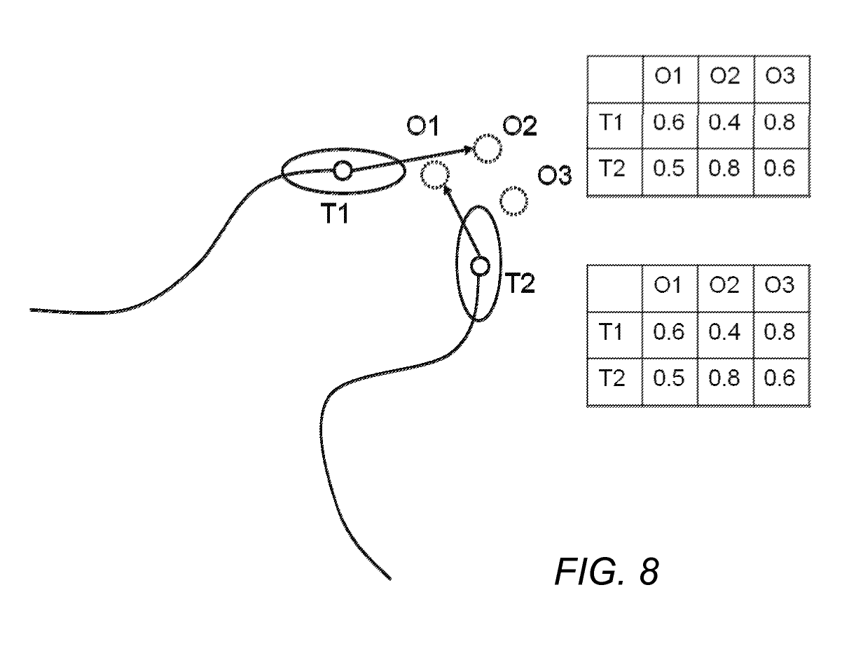

In the Tracking Phase 120, Euclidean distance plus appearance dissimilarity may be used (See FIG. 8). This provides a fusion of geometry plus appearance clues. Specifically, in a subsequent frame, the target position is estimated using, for example, an “image-based-ground-plane-median-shift” algorithm, discussed hereinafter, which uses the 4D target appearance model. The target appearance at the new location is extracted as discussed above in the Modeling Phase 110. The original and new appearances are then compared by computing a Bhattacharya distance between them. The estimated/measured location may thereafter be provided to a tracking filter (e.g., Kalman Filter) along with a measurement error estimate which is proportional to the distance computed above.

Having a new target appearance, the original target appearance may now be updated for a more robust system. The weight given to the new appearance is a function of a user defined “learning rate” as well as the distance previously computed. The updated target appearance becomes the “original” target appearance.

Thereafter, target confidence may be checked. For example, if the tracking filter state covariance becomes very high, it may result in an indication of tracking failure.

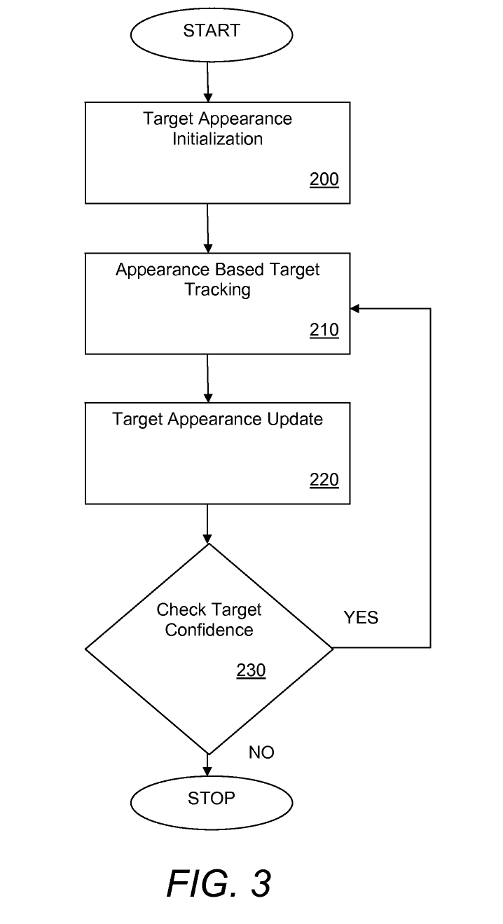

Specific details of an embodiment of the invention shown in FIG. 3 will now be described. FIG. 3 shows the process for tracking with updating and confidence checking. In this embodiment, the steps include Target Appearance Initialization 200, Appearance Based Target Tracking 210, Target Appearance Update 220, and a Target Confidence Check 230, each of which will be described in detail herein.

Target Appearance Initialization 200 begins with acquiring user input. Known intelligent video technologies with video analytics may be used. Embodiments include an intuitive user interface that displays video acquired through multiple cameras in real time along with extracted meta-data (real-time). The appearance based tracking approach builds upon this video-analytics graphical interface, which is used to capture user interaction in the form of “clicks” of a pointing device (mouse) over any of the video streams being displayed (See FIG. 9).

Target shape modeling occurs next with reference to FIG. 4. The target (object of interest) shape is modeled in 3D. For example, a human full body may be modeled in 3D physical space by a 3D ellipsoid, which may be defined by six parameters. They are the (i) height, (ii) length, and (iii) width of the ellipsoid representing the physical size of a person, (iv) the rotation angle along vertical z-axis describing the orientation of the person, as well as (v) the ground plane x and (vi) the ground-plane y position where the ellipsoid stands. Given this parameterization of the 3D ellipsoid, a discretized representation of this shape model is created using a mesh model where a triangular mesh covering the 3D model is generated using a set of vertices that are uniformly distributed along the surface of the 3D ellipsoid. These 3D vertices, when imaged by a camera with the known camera geometry, are then projected onto the 2D image plane. The convex hull of these 2D points is computed, which can compactly cover all these points with a convex polygon. This polygon in the 2D image thus provides a good approximation of the region occupied by a person at a particular ground-plane location and orientation when the person is captured and viewed by the camera.

All image features located inside this 2D polygon thus uniquely characterize the appearance properties of this person. The image features could be 1) the number of pixels classified as “foreground” (by another algorithm that performs per-frame foreground background separation) inside this polygon; 2) the color histogram distribution of the person, which captures the color patterns of person's clothes thus serves as a unique appearance signature of the person, etc.

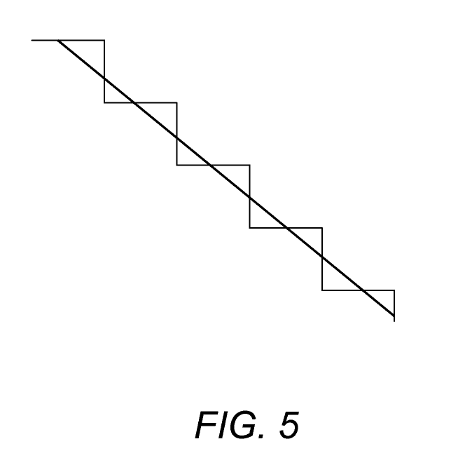

In order to enable fast computation of such features, the 2D polygon may be approximated by a “rectilinear polygon”. The rectilinear polygon assumes that each edge of the polygon has either horizontal or vertical orientation. Based on this rectilinear polygon shape and integral computation principle, a very efficient algorithm may be derived for computing the image features inside the shape, thus lowering the computational complexity of such an operation. The rectilinearization of the projected 2D polygon is conducted by approximating each edge of the polygon with a set of horizontal-vertical zigzag triangles, see FIG. 5. A rectilinearization algorithm can approximate the original polygon with arbitrary degree of accuracy. After this rectilinearization, the original polygon then becomes a rectilinear polygon, and it then can allow the fast computation of image features inside this shape with integral computation method.

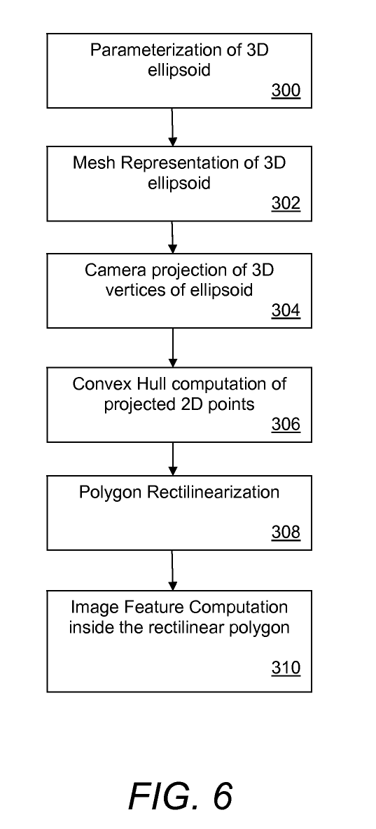

The flowchart shown in FIG. 6 describes computation of a 2D silhouette of the target (object/person of interest). This silhouette can potentially be used for fast computation of image based features corresponding to the object/person of interest. The steps include parameterization of the 3D ellipsoid 300, mesh representation of 3D ellipsoid 302, Camera projection of 3D vertices of ellipsoid 304, convex hull computation of projected 2D points 306, Polygon rectilinearization 308, and image feature computation inside the rectilinear polygon 310,

The next step is appearance modeling. User input is obtained in the form of a mouse click on the graphical user interface, such that the point clicked is the location of the person on the ground-plane (foot location). Using this location and an empirical average height of a person (say 1.8 m), the rectilinear polygon is computed (as described above). For each pixel inside the rectilinear polygon appearance features are extracted like, the color (R, G, B) as well as the approximate real-world “height” (h) corresponding to each pixel. Thus using these four attributes of each pixel inside the rectilinear polygon, a 4D histogram is constructed, which embeds the appearance information of the person-of-interest. This histogram is used as the “appearance model” of the person-of-interest (POI). Such a model can be constructed independently for each camera view in which the POI is visible (or if the chromatic properties of the different cameras are known, a single appearance model can be shared across all cameras).

The next step is appearance based tracking using shape prior 210. Given the location of the POI as well as the appearance model, the ground-plane location of the POI is tracked in subsequent frames, in any camera view. This may be accomplished by an Image-Based Ground-Plane Median-Shift algorithm. The image-based ground-plane median-shift algorithm is used to track the location of the POI using the appearance information as well as the shape priors.

The following explains how this algorithm is used to approximate the current location of the POI. The following definitions are provided: (1) previous frame ground-plane (3D) location of target=curr_gp_loc, (2) previous frame 2D silhouette of target=curr_silhouette, (3) target histogram=H_orig, (4) Initial candidate location (3D) in the current frame=cand_gp_loc=curr_gp_loc, (5) Initial candidate 2D silhouette of target=cand_silhouette=curr_silhouette, (6) candidate histogram=H_cand (computed over pixels in cand_silhouette), (7) Rho=Bhattacharya coefficient between H_cand and H_orig.

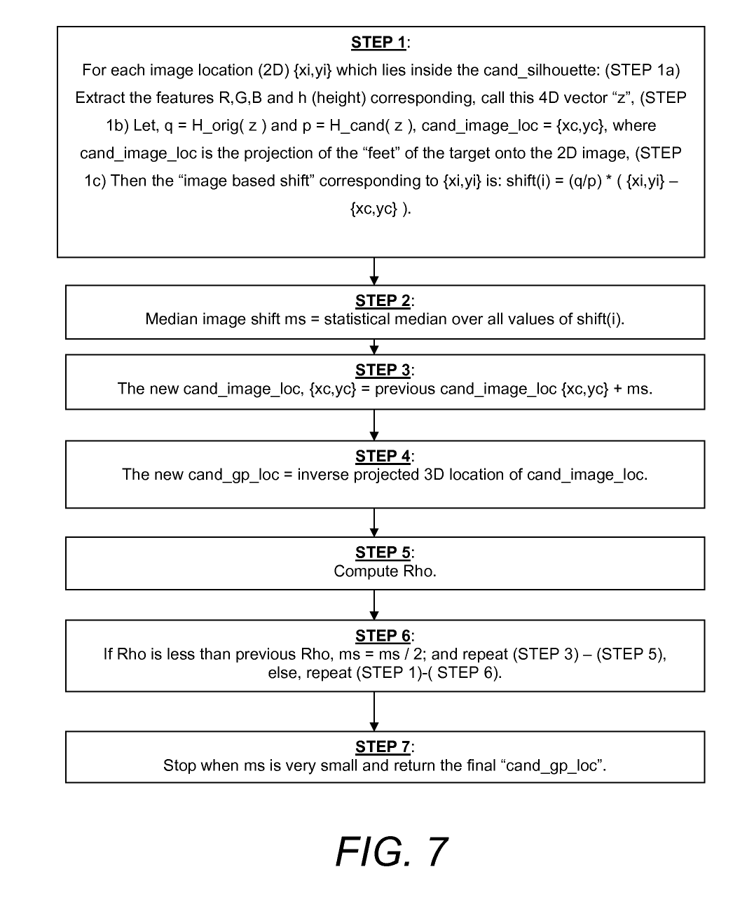

Then the algorithm proceeds as follows as shown in FIG. 7:

STEP 1: For each image location (2D) {xi,yi} which lies inside the cand_silhouette: (STEP 1a) Extract the features R, G, B and h (height) corresponding, call this 4D vector “z”, (STEP 1b) Let, q=H_orig(z) and p=H_cand(z), cand_image_loc={xc,yc}, where cand_image_loc is the projection of the “feet” of the target onto the 2D image, (STEP 1c) Then the “image based shift” corresponding to {xi,yi} is: shift(i)=(q/p)*({xi,yi}−{xc,yc}).

STEP 2: Median image shift ms=statistical median over all values of shift(i).

STEP 3: The new cand_image_loc, {xc,yc}=previous cand_image_loc {xc,yc}+ms.

STEP 4: The new cand_gp_loc=inverse projected 3D location of cand_image_loc.

STEP 5: Compute Rho.

STEP 6: If Rho is less than previous Rho, ms=ms/2; and repeat (STEP 3)-(STEP 5), else, repeat (STEP 1)-(STEP 6).

STEP 7: Stop when ms is very small and return the final “cand_gp_loc”.

Thereafter, Kalman Filtering may be applied. Kalman filtering is a standard technique used to filter the estimated/measured POI location using a simple linear approximation.

Next is the step of Target Appearance Update 220. The original appearance model (histogram) is maintained and is updated as required when there is the appearance model from the new ground plane location of the POI after Kalman filtering above. This is accomplished by letting H_orig be the original (normalized) histogram and H_new (normalized) be the appearance histogram obtained for the current ground-plane location of the POI. The rectilinear polygon for the current location is computed. Then, let {r, g, b, h} be the attributes of a pixel inside the rectilinear polygon. Let p=H_new(r,g,b,h), i.e., the bin strength corresponding to the attributes of the pixel in the 4D histogram. Let c=appearance confidence i.e., a measure that provides a figure of merit for the quality of the appearance extracted from the new ground-plane location of the POI, which might be measured based on the distance from the camera, occlusion, etc. Let alpha=“learning rate”, i.e., how fast do we want the original appearance be updated to the current appearance (a measure of inertia of the original appearance model). Then the original histogram is updated in the following manner: H_orig(r,g,b,h)=H_orig(r,g,b,h)+(p*c*alpha). After we update H_orig using information from the pixels in the new rectilinear polygon, H_orig is normalized using the sum over all the histogram bins, such that the summation over all bin values of this normalized histogram is one.

Next is the step of Checking Target Confidence 230 as follows: When the Kalman Filter state estimate of the ground plane location has a very high covariance, it may be assumed that the track of the POI is lost and either the POI has moved out of the scene or the operator needs to re-initialize the appearance model over the POI.

An advantage that may be realized in the practice of some embodiments of the described systems and techniques is that the 3D appearance model of the object/person is invariant to changes in pose and apparent size of the object/person as it moves in the scene. Moreover, since the appearance model of the object/person is composed of a four dimensional 4D histogram, it allows appearance matching in spite of partial occlusions and leads to a robust tracking performance. Still further, since the system does not depend on a separate object/person detector, the speed of tracking is improved and the possibility of inaccurate tracking (e.g. when the detector cannot find the object/person of interest) is reduced.

For example, since a 3D appearance model of the object/person is used, it is invariant to changes in pose and apparent size of the object/person as it moves in the scene. For example, a simple ellipsoidal shape prior may be used during appearance acquisition as well as tracking (mean-shift) which leads to robust as well as faster tracking. The appearance model of the object/person is composed of a 4 dimensional histogram (3 color channels+1 normalized 3D height with respect to the ground plane). This allows appearance matching in spite of partial occlusions and leads to a robust tracking performance. The appearance model may be updated continuously using the current location of the object/person, taking into account possible occlusions as well. Accordingly, the system does not depend on a separate object/person detector which improves the speed of tracking as well as reduces possibility of inaccurate tracking (e.g. when the detector cannot find the object/person of interest). The appearance model+shape priors used here are very generic and can be easily applied to any object type and shape as long as the “appearance” of the object is able to discriminate is from other similar objects. The person of interest is tracked using a single user “click”, which keeps the interaction very simple and thereby improves the ease of use.

Software programming code which embodies aspects of the present invention is typically stored in permanent storage of some type, such as the permanent storage of the computer workstation. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

An exemplary system for implementing aspects of the invention includes a computing device or a network of computing devices. In a basic configuration, computing device may include any type of stationary computing device or a mobile computing device. Computing device typically includes at least one processing unit and system memory. Depending on the exact configuration and type of computing device, system memory may be volatile (such as RAM), non-volatile (such as ROM, flash memory, and the like) or some combination of the two. System memory typically includes operating system, one or more applications, and may include program data. Computing device may also have additional features or functionality. For example, computing device may also include additional data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules or other data. System memory, removable storage and non-removable storage are all examples of computer storage media. Any such computer storage media may be part of device. Computing device may also have input device(s) such as a keyboard, mouse, pen, voice input device, touch input device, etc. Output device(s) such as a display, speakers, printer, etc. may also be included. Computing device also contains communication connection(s) that allow the device to communicate with other computing devices, such as over a network or a wireless network. By way of example, and not limitation, communication connection(s) may include wired media such as a wired network or direct-wired connection, and wireless media such as acoustic, RF, infrared and other wireless media.

Computer program code for carrying out operations of aspects of the invention described above may be written in a high-level programming language, such as C or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller. A code in which a program of embodiments of the present invention is described can be included as a firmware in a RAM, a ROM and a flash memory. Otherwise, the code can be stored in a tangible computer-readable storage medium such as a magnetic tape, a flexible disc, a hard disc, a compact disc, a photo-magnetic disc, a digital versatile disc (DVD). Aspects of the present invention can be configured for use in a computer or an information processing apparatus which includes a memory, such as a central processing unit (CPU), a RAM and a ROM as well as a storage medium such as a hard disc.

The “step-by-step process” for performing the claimed functions herein is a specific algorithm, and may be shown as a mathematical formula, in the text of the specification as prose, and/or in a flow chart. The instructions of the software program create a special purpose machine for carrying out the particular algorithm. Thus, in any means-plus-function claim herein in which the disclosed structure is a computer, or microprocessor, programmed to carry out an algorithm, the disclosed structure is not the general purpose computer, but rather the special purpose computer programmed to perform the disclosed algorithm.

A general purpose computer, or microprocessor, may be programmed to carry out the algorithm/steps of embodiments of the present invention creating a new machine. The general purpose computer becomes a special purpose computer once it is programmed to perform particular functions pursuant to instructions from program software of the embodiments of the present invention. The instructions of the software program that carry out the algorithm/steps electrically change the general purpose computer by creating electrical paths within the device. These electrical paths create a special purpose machine for carrying out the particular algorithm/steps.

Unless specifically stated otherwise as apparent from the discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An object tracking system for tracking an object, the object tracking system comprising:
one or more image capture devices monitoring a scene; and
an image processing system coupled to the one or more image capture devices, the image processing system having a memory, a processor, wherein the processor is programmed to:
receive at least one two-dimensional image comprising an object of interest captured via the one or more image capture devices;
generate a three-dimensional (3D) shape model from the 2D image;
construct an appearance model from the 3D shape model combined with extracted appearance features from the 2D image;
track the object of interest in the scene;
output tracking information for the object of interest.

2. The system of claim 1 wherein the image capture device comprises one or more of a camera, a pan-tilt-zoom camera, a wide-angle electronic zoom camera, a video camera, a thermal camera, and an electro-optical sensor.

3. The system of claim 1 wherein the object of interest is a person of interest within a field of view of at least one image capture device monitoring the scene, wherein the object of interest is displayed on a screen and wherein the system receives input from an operator to track the object of interest from the scene displayed on the screen, wherein the input identifies positional information for the object of interest.

4. The system of claim 3 wherein the input comprises one or more of (a) an input from a graphical user interface input device that allows for selection of a location and a pose of the object of interest on a ground-plane in the scene to initialize a target location or (b) an event automatically generated by the image processing system upon satisfying certain preset criteria.

5. The system of claim 1 wherein the 3D shape model is generated from the 2D image by approximating a shape of the object of interest as a 3D ellipsoid.

6. The system of claim 1 wherein a generic vertex-edge-facet based 3D shape model is generated from the 2D image.

7. The system of claim 1 wherein the 3D shape model is generated from the 2D image by approximating a shape of the object of interest and wherein a 2D projection silhouette of the object of interest is pre-computed using image capture device parameters.

8. The system of claim 7 wherein generating the shape 3D model further comprises extracting appearance features from pixels inside the 2D projection silhouette wherein the extracted appearance features comprise color information.

9. The system of claim 8 wherein the appearance model is constructed from the 3D shape model by combining the extracted appearance features into a 4D histogram comprising color and an approximated height (h).

10. The system of claim 1 further comprising tracking the object of interest using Euclidean distance and appearance dissimilarity based on the appearance model to locate target appearances in a tracking image corresponding to the appearance model.

11. The system of claim 10 wherein the object is tracked using an image-based-ground-plane-median-shift algorithm, comprising:
locating one or more possible target appearances in a tracking image;
computing a distance between the appearance model and the one or more possible target appearances;
comparing the appearance model with the one or more possible target appearances based on distance and appearance dissimilarity;
selecting one target appearance out of the one or more possible target appearances based on the comparison; and
updating the appearance model with information from the selected one target appearance.

12. A method of object tracking in an image processing system, the method comprising:
capturing via one or more image capture devices monitoring a scene a two-dimensional (2D) image comprising an object of interest;
generating via a processor in an image processing system a three-dimensional (3D) shape model from the 2D image;
obtaining via the processor an appearance model from the 3D shape model combined with extracted appearance features from the 2D image;
tracking the location of the object of interest in the scene; and
outputting tracking information for the object of interest.

13. The method of claim 12 wherein the image capture device monitors a scene comprising one or more of a camera, a pan-tilt-zoom camera, a wide-angle electronic zoom camera, a video camera, a thermal camera and an electro-optical sensor.

14. The method of claim 12 wherein the object of interest is a person of interest within a field of view of at least one image capture device monitoring a scene.

15. The method of claim 12 further comprising displaying on a screen a field of view from at least one image capture device monitoring a scene and receiving input from an operator to track the object of interest from the scene displayed on the screen, wherein the input identifies positional information for the object of interest.

16. The method of claim 15 wherein the input comprises an input from a graphical user interface input device that allows for selection of a location and a pose of the object of interest on a ground-plane in the scene to initialize a target location.

17. The method of claim 15 wherein the input comprises an event generated by the image processing system.

18. The method of claim 15 wherein the event comprises a command to track the object of interest upon satisfying certain preset criteria.

19. The method of claim 12 wherein the 3D shape model is generated from the 2D image by approximating a shape of the object of interest as a 3D ellipsoid.

20. The method of claim 12 wherein a generic vertex-edge-facet based 3D shape model is generated from the 2D image

21. The method of claim 12 wherein the 3D shape model is generated from the 2D image by approximating a shape of the object of interest and wherein a 2D projection silhouette of the object of interest is pre-computed using image capture device parameters.

22. The method of claim 21 further comprising extracting appearance features from pixels inside the 2D projection silhouette.

23. The method of claim 22 wherein the extracted appearance features comprise color information.

24. The method of claim 23 wherein the appearance model is constructed from the 3D shape model by combining the extracted appearance features into a 4D histogram comprising color and an approximated height (h).

25. The method of claim 12 further comprising tracking the object of interest using Euclidean distance and appearance dissimilarity based on the appearance model to locate target appearances in a tracking image corresponding to the appearance model.

26. The method of claim 25 wherein the object is tracked using an image-based-ground-plane-median-shift algorithm.

27. The method of claim 25 wherein the object is tracked by:
locating one or more possible target appearances in a tracking image;
computing a distance between the appearance model and the one or more possible target appearances;
comparing the appearance model with the one or more possible target appearances based on distance and appearance dissimilarity;
selecting one target appearance out of the one or more possible target appearances based on the comparison; and
updating the appearance model with information from the selected one target appearance.

28. The method of claim 27 further comprising computing a confidence level to determine tracking success or failure for the selected one target appearance and if tracking success is determined, continuing tracking, otherwise outputting an indication of tracking failure.

29. The method of claim 25 further comprising one or more steps positioning of tracking cameras based on the outputted tracking information and displaying a trace on the screen while tracking.

30. A computer readable medium for implementing object tracking in an image processing system, including code devices for:
capturing via one or more image capture devices monitoring a scene a two-dimensional (2D) image comprising an object of interest;
generating via a processor in an image processing system a three-dimensional (3D) shape model from the 2D image;
obtaining via the processor an appearance model from the 3D shape model combined with extracted appearance features from the 2D image;
tracking the location of the object of interest in the scene; and
outputting tracking information for the object of interest.
